(19) United States
(12) Patent Application Publication
(10) Pub. No.: US 2025/0090999 A1
(43) Pub. Date: Mar. 20, 2025

(54) PULSED ABSORPTION CONTACTOR

(71) Applicant: NUOVO PIGNONE TECNOLOGIE SRL, Florence (IT)

(72) Inventors: Jeremy Daniel Van Dam, Edmond, OK (US); Jason Angolano, Moore, OK (US)

(21) Appl. No.: 18/468,912

(22) Filed: Sep. 18, 2023

(51) Int. Cl. B01D 53/18; B01D 53/14

(52) U.S. Cl. CPC B01D 53/185; B01D 53/1412; B01D 53/1475; B01D 2257/504

(57) ABSTRACT

Pulsed absorption contactor systems and methods are provided. The systems include a vessel having inlet and outlet ends and a pulse generator system, a gas inlet configured to direct an input gas stream into the vessel, a gas outlet configured to receive an output gas stream and direct the output gas stream out of the vessel, a liquid inlet configured to direct an input liquid stream into the vessel, and a liquid outlet configured to receive an output liquid stream and direct the output liquid stream out of the vessel. The pulse generator system is configured to induce a fluctuation in the input gas stream, the input liquid stream, and/or a combination of the input gas stream and the input liquid stream.

### BACKGROUND

In industrial processing, power generation, and other similar industries, capture of various byproducts and/or generated gases may be necessary or desirable. For example, capture of environmentally threatening gasses such as CO₂ from the exhaust streams of hydrocarbon-fueled processes has become a necessity. Regulation of allowable CO₂ emissions now limits the economic viability of power generation and other large scale industrial facility operations. Furthermore, such capture technologies may be used for other chemicals and/or processes, including, without limitation: natural gas production, sweetening, and the like.

Typical absorbers may utilize a static, fixed surface area on which the absorption occurs. For example, a common absorber design is a “shaped packing” design. In this design, packing elements with complex surface shapes are placed in a fixed-size chamber. A liquid solvent is typically caused to flow downwardly through the chamber and wet the exterior surfaces of the packing elements. With a liquid solvent present, a gas is then driven upwardly through the packing elements. The aim of such packing elements is to increase a surface area for mass transfer between the solvent and the gas that are directed into/through the fixed-size chamber, and a selected component of the gas is absorbed into a surface of the solvent. The surface area of the packing elements remains fixed and static. The three commercial types of packing are random, structured trays, and spray towers.

A common limitation of such absorbers is the relatively short amount of time in which the two fluids (gas to be captured and liquid solvent) are in surface contact with each other. The static, fixed surface area designs typically use a counter-flow arrangement wherein the solvent flows downwardly and the gas flows upwardly. Such counter-flow technique is utilized to maximize the concentration gradient between the two fluids but has the inherent limitation of minimizing the time in which the surfaces of the two fluids are in contact. Accordingly, to accommodate such limitation on duration of contact, this conventional system may require a significant height of packing elements required (e.g., vertically stacked) to facilitate the absorption process.

Recent advancements in continuous post-combustion capture technologies have demonstrated that the size and cost of equipment can be dramatically reduced through development of new processes (e.g., chemical and/or mechanical). One of such technologies is the Regenerative Froth Contactor (RFC) which may be able to increase the mass-transfer between carbon-rich flue gasses and absorbent liquid solvents by a factor greater than five. The primary mechanism allowing increased mass transfer is the generation of a pulsating flow regime inside a gas-liquid contactor such that the majority of the internal volume of the contactor is occupied by a pulsating froth of micro-scale gas bubbles and liquid droplets.

U.S. Pat. No. 11,484,860 discloses an apparatus for enhancing a yield and a transfer rate of a packed bed that includes a packed bed (e.g., packing elements), a vessel having a reaction chamber, a support frame and acoustic attenuator for holding the packed bed in the reaction chamber, at least one acoustic transducer adapted to transmit acoustic energy into the packed bed, and an acoustic generator. The acoustic transducer is located within and part of the packed bed and/or arranged on the outside of the packed bed. The acoustic generator has impedance matching functionality. The system disclosed therein is directed to applying the acoustic transducer directly to the packed bed and is designed for adsorption by vibrating the packed bed with the acoustic energy. The system employs a counter-flow arrangement where a gas and a liquid are directed in opposite directions through a vessel that includes the packed beds with integrated acoustic transducers.

The prior solution systems may require relatively expensive materials in their construction and may require very large and/or vertically tall processing towers/facilities. The large surface area of the packing element, which is required to facilitate absorption, also makes such systems susceptible to build up of contaminates within the contactor (e.g., dirt, impurities from the gas and/or liquid, or precipitation products from the absorption itself). Accordingly, improved systems for gas absorption into a solvent may be desirable to provide various advantages, such as reduced costs, increased efficiencies, and reduced facility size (with accompanying benefits thereof).

### SUMMARY

In accordance with some embodiments, pulsed absorption contactor systems are provided. The systems include a vessel having an inlet end and an outlet end. The vessel includes at least one gas inlet arranged at the inlet end of the vessel and configured to direct an input gas stream into the vessel, at least one gas outlet arranged at the outlet end of the vessel and configured to receive an output gas stream and direct the output gas stream out of the vessel, at least one liquid inlet arranged at the inlet end of the vessel and configured to direct an input liquid stream into the vessel, and at least one liquid outlet arranged at the outlet end of the vessel and configured to receive an output liquid stream and direct the output liquid stream out of the vessel. A pulse generator system is configured to induce a fluctuation in at least one of the input gas stream, the input liquid stream, or a combination of the input gas stream and the input liquid stream. An induced pulse from the pulse generator system creates a compression wave of a mixture of a gas of the input gas stream and a liquid of the input liquid stream within the vessel.

In accordance with some embodiments, methods for capturing a target component from a gas within a liquid are provided. The methods employ a pulsed absorption contactor system having a vessel with an inlet end and an outlet end and a pulse generator system. The methods include supplying an input gas into the vessel through a gas inlet at the inlet end of the vessel, supplying an input liquid into the vessel through a liquid inlet at the inlet end of the vessel, and inducing a pressure wave within the vessel using the pulse generator system configured to induce a pulse in at least one of the input gas, the input liquid, and a mixture of the input gas and the input liquid, wherein an induced pulse from the pulse generator system creates a compression wave of a mixture of the input gas and the input liquid within the vessel.

### BRIEF DESCRIPTION OF THE DRAWINGS

The following descriptions should not be considered limiting in any way. With reference to the accompanying drawings, like elements are numbered alike:

FIG. 1 is a schematic illustration of a gas absorber that may be modified to incorporate embodiments of the present disclosure;

FIG. 2 is a schematic illustration of a counter-current absorber system;

FIG. 3 is a schematic illustration of a co-current absorber system generating a froth pulsation;

FIG. 4 is a schematic illustration of a pulsed absorption contactor in accordance with an embodiment of the present disclosure; and

FIG. 5 is a schematic illustration of another configuration of a pulsed absorption contactor in accordance with another embodiment of the present disclosure.

### DETAILED DESCRIPTION

A detailed description of one or more embodiments of the disclosed apparatus and method are presented herein by way of exemplification and not limitation with reference to the Figures.

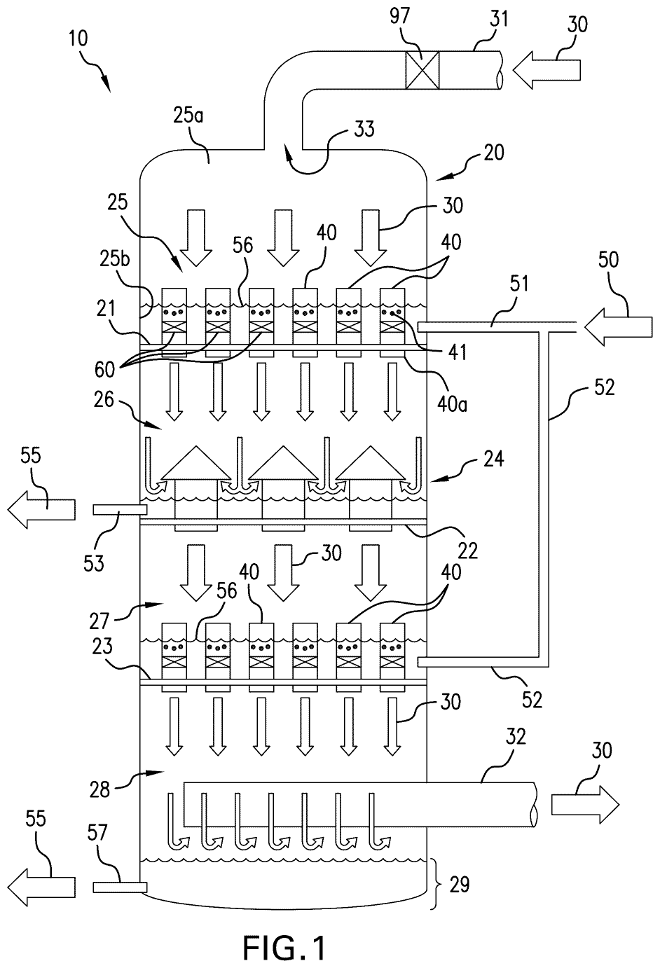

Referring to FIG. 1, an example of a gas absorber 10 that may be modified to incorporate embodiments of the present disclosure is shown. The gas absorber 10 includes a reaction or absorber vessel 20 which, as shown, is a cylindrical, vertically extending vessel. Due to the nature of gas absorption systems, as described above, the absorber vessel 20 may, in some uses and configurations, exceed 15 meters in diameter and may be significantly taller in the vertical direction. Although illustrated as a cylinder, it will be appreciated that the absorber vessels described herein may be virtually any shape, and have cross-sections which are circular, oval, rectangular, polyhedral, or other shape.

In operation, an incoming flow gas stream 30 such as flue gas from a power plant (e.g., fossil fuel or other fuel source), flows into an inlet duct 31 connected to an inlet port 33 at the top or upper end of the absorber vessel 20. The gas stream 30 contains a selected component, chemical, compound, or the like. The incoming flowing gas stream 30 flows downwardly through the absorber vessel 20, and after being subjected to an absorption process described herein, the processed gas is discharged through an outlet duct 32.

In this illustrative configuration, the absorber vessel 20 has a first chamber 25 and a second chamber 26 separated by a bulkhead plate 21 extending horizontally across the absorber vessel 20. The first chamber 25 is fluidly connected to the gas inlet duct 31 to allow a flow of the gas stream 30 into the first chamber 25. The bulkhead plate 21 extends across an outlet end 25b of first chamber 25 and separates the first chamber 25 from the adjacent second chamber 26, which is arranged vertically beneath the first chamber 25.

An array of discrete, vertically oriented absorption tubes 40 are arranged in respective flow ports 40a formed through the bulkhead plate 21. Each of the absorption tubes 40 extends through the bulkhead plate 21 in an upward direction and into first chamber 25 to define a respective conduit for the flow of the gas stream 30 from the first chamber 25 into the second chamber 26. The absorption tubes 40 may be arranged in any one of a number of possible geometric shapes, as will be appreciated by those of skill in the art (e.g., circular, square, oval, polygonal, etc. in cross-section). The flow ports 40a and the absorption tubes 40 are sized and positioned to equalize a flow speed of the gas stream 30 downwardly through each absorption tube 40 from the first chamber 25 into the second chamber 26.

In this illustrative configuration, a fan 97 is provided within the inlet duct 31. The fan 97 provides means for pressurizing the gas stream 30 in the first chamber 25 and to cause a back pressure in the first chamber 25, which in turn causes the gas stream 30 to flow at substantially the same, equal flow rates through each of the absorption tubes 40 into the second chamber 26. It will be appreciated that the fan 97 may be arranged at other locations and/or may be configurated as some other type of pressure generator (e.g., pump, compressor, controlled valve, etc.). As shown in FIG. 1, an optional second bulkhead plate 23 (similar to bulkhead plate 21) is arranged vertically below the first bulkhead plate 21 to form an additional set of chambers, including a third chamber 27 and a fourth chamber 28, which are substantially the same as the configuration of the first and second chambers 25, 26.

The array of discrete, vertically oriented absorption tubes 40 are densely mounted to and arranged in the flow ports 40a in the bulkhead plates 21, 23. The absorption tubes 40 are mounted perpendicular to the bulkhead plates 21, 23 and arranged parallel with a vertical axis of the absorber vessel 20. The number of absorption tubes 40 required on each stage (e.g., mounted to each bulkhead plate 21, 23) may be dependent upon the gas flow, a liquid flow through the absorber vessel 20, and/or based on other factors. For example, depending on the specific configuration and desired use, each stage may include as few as a single absorption tube 40 or may include many thousands of such absorption tubes 40. Each of the absorption tubes 40 extends through the respective bulkhead plate 21, 23 to define a respective conduit for the flow of gas stream 30 from first chamber 25 into second chamber 26 or from the third chamber 27 into the fourth chamber 28. The absorption tubes 40 and the associated flow ports 40a holding or carrying the absorption tubes 40 are sized and positioned to equalize a flow speed of the gas stream 30 downwardly through each absorption tube 40 from the respective upstream chambers 25, 27 to respective downstream chambers 26, 28.

The mechanism to absorb the desired chemical, compound, or material to be captured, is provided by introducing a liquid solvent into the absorber vessel 20. For example, a lean liquid solvent 50 may be fed into the absorber vessel 20 above the first bulkhead plate 21 through one or more inlet lines 51 to flood the space above the first bulkhead plate 21. Such liquid solvent will surround and fill the space between the absorption tubes 40 and thus form a solvent reservoir 56. The liquid solvent 50 may be any solvent capable of absorbing the selected component, chemical, compound, etc.

Each absorption tube 40 may be arranged with a screen assembly 60 arranged therein. The screen assembly 60 may be a packing material or packing elements with complex surface shapes (e.g., complex screens). For example, each screen assembly 60 may be formed of a stack of screens or mesh material that provide a high level of surface area while providing through paths therethrough to permit a liquid-gas mixture to flow through and interact with the material/structures of the screen assembly 60. Further, each absorption tube 40 may include fluid inlets for receiving both a portion of the gas stream 30 and a portion of the liquid solvent 50. The fluid inlets on the absorption tubes 40 for permitting the liquid solvent 50 to enter the absorption tubes 40 may be arranged as holes 41 (e.g., holes, slots, apertures, or the like). The gas stream 30 may be directed through open tops of the absorption tubes 40, or may flow through one or more holes, apertures, slots or the like.

In operation, the liquid solvent 50 flows through the holes 41 into each of the absorption tubes 40. With the liquid solvent 50 within the absorption tube 40, and the gas stream 30 being directed therethrough, the two fluids may interact within the absorption tubes 40. For example, the liquid solvent 50 may interact with the screen assembly 60 (also referred to as a “froth generator”) to mix with the gas stream 30 and establish froth droplets and bubbles (both not shown for clarity). In other configurations, the liquid solvent 50 may simply flow over the top of the absorption tubes 40, and enter through an open top thereof, thus negating the need for the holes 41. In such configurations, the top of the absorption tubes 40 may have notches to allow the liquid solvent 50 to drain at set points into the absorption tube 40 or a lip of the absorption tube 40 may be smooth (e.g., without notches) to create an even flow of the liquid solvent 50 over the entire top of the absorption tubes 40. Each of these techniques injects the liquid solvent 50 into each of the absorption tubes 40 and through a plurality of screen assemblies 60 provided in each absorption tube 40 to form an aqueous bubbly froth from the liquid solvent inside each of the absorption tubes 40 as the gas stream 30 flows through the absorption tubes 40.

The screen assemblies 60 may be formed of one or more (e.g., a set) of mesh screens Each mesh screen extends transversely between side walls of each tube 40. As such, the mesh screens of the screen assemblies 60 provide a tortuous flow path through which the mixture of the gas stream 30 and the liquid solvent 50 may interact. In some configurations, the screen assemblies 60 may include an array of screens. The screens of the screen assemblies 60 are configured to burst, shatter, fragment, or break up the bubbles of the aqueous froth into a myriad of droplets and micro-droplets of different radii. Such treatment of the mixture may create a very large, rapidly changing solvent surface, as described in detail in U.S. Pat. No. 7,854,791, the contents of which are incorporated herein in their entirety. The screen assemblies 60 may include plurality of vertically spaced apart mesh screens (e.g., a stack). Each screen may have any of a variety of cross-sectional geometries or shapes, including ridge shaped screens, undulating screens, flat mesh screens, etc. A mesh or screen size may be selected to permit the fluid mixture to pass through but with sufficient obstruction to such flow of fluid mixture to cause the treatment of the gas-liquid mixture to increase a surface area of the liquid to absorb the gas, as will be appreciated by those of skill in the art.

The injection or introduction of the liquid solvent 50 into each of the absorption tubes 40 may be done by various techniques as will be appreciated by those of skill in the art. The introduction and/or injection of the liquid solvent 50 into the absorption tubes 40 will form an aqueous froth in each absorption tube 40. With the inclusion of the screen assemblies 60, bubbles that are present in the froth will burst, reform, and burst repeatedly to form numerous micro-droplets of different radii, thereby creating a rapidly changing surface area for absorption of the component, chemical, or compound of interest. In some configurations, in order to deliver the leanest liquid solvent 50 to each stage, the liquid solvent 50 may be fed directly to each stage through a dedicated inlet line 51, 52.

In configurations where separation of the gas and liquid is required, multiple liquid/gas separators 24 may be mounted directly below the absorption tubes 40 (e.g., in the second chamber 26). One possible form of these liquid/gas separators 24 is shown, but various other configurations may be employed without departing from the scope of the present disclosure. The liquid/gas separators 24 may be supported or mounted on a separator bulkhead plate 22. The separator bulkhead plate 22 may also substantially separate the second chamber 26 from the third chamber 27, with the liquid/gas separators 24 providing fluid connection therebetween. For example, the passageways through the liquid/gas separators 24 establish fluid (gas) communication between an initial dewatering chamber (e.g., second chamber 26) and a next absorber stage (e.g., third chamber 27) of the gas absorber 10. In this operation, the liquid falls and settles into the space between around the liquid/gas separators 24 and on the separator bulkhead plate 22 and can be drawn off as a continuous liquid stream through a rich solvent drain line 53 to be regenerated into lean solvent, which may be recycled back into the gas absorber 10 at the inlet lines 51, 52. The gas stream 30, in turn, passes through the liquid/gas separator 24 and into the next absorber stage (e.g., third chamber 27). It will be appreciated that the need to remove the liquid solvent (absorbent) after each stage may be dependent on the requirements of each application, and thus such separator stage may be omitted or additional separator stages may be provided, as will be appreciated by those of skill in the art.

Although a specific configuration of the gas absorber 10 is illustrated, various other configurations are possible without departing from the scope of the present disclosure. For example, in other configurations, all of the liquid solvent may be directed to enter the absorber vessel 20 via a single line at the top of the absorber vessel 20 and will pass through the multiple stages of the absorber vessel 20 to be removed at the bottom thereof (e.g., by an absorber sump or the like). As illustratively shown, the gas stream 30 and the liquid solvent 50 leaving the absorber tubes 40 flows into the next stage in the absorber vessel 50. In applications where liquid absorbent removal is not required, the partially spent absorbent from the first stage may be directed to fall or be pumped into a liquid-absorbent reservoir of the next stage, and in-turn enter the absorber tubes 40 of the subsequent stage.

A final dehydration stage may be provided within the fourth chamber 28. The dehydration stage may include a rich-solvent reservoir 29 in the bottom of the absorber vessel 20. A horizontal gas outlet duct 32 may be arranged to project through the vessel wall of the absorber vessel 20 in the fourth chamber 28 to allow the gas stream 30 to leave the absorber vessel 20.

As noted above, fresh or lean liquid solvent 50 may be delivered to the absorber vessel 20 through the inlet line 51 and/or in the case of multiple inlets, the inlet lines 51, 52. Rich solvent 55 (the solvent already used to absorb components from the gas) may exits through a drain 57 at the bottom of absorber vessel 20 and/or through the solvent drain line 53 at an intermediate stage of the processing through the gas absorber 10. The rich solvent 55 may be directed to a solvent regeneration system and then recycled and/or reused within the gas absorber 10 or may be used for other purposes, as will be appreciated by those of skill in the art. For example, a solvent regeneration system may employ heat and/or a vacuum to strip the component, compound, or chemical which has been removed from the gas stream 30 from the rich solvent 55 so that the regenerated solvent can in turn be reused in the gas absorber 10.

Although illustrated as a substantially co-current flow with both the liquid solvent 50 and the gas stream 30 traveling in a vertically downward direction, other configurations are possible. For example, a counter-current configuration may be arranged to direct one of the liquid solvent and the gas stream in a downward direction and the other of the liquid solvent and the gas stream in an upward direction. This counter-current configuration may be used to increase the froth and absorption of the target gas within the liquid solvent. Such systems may be relatively more complex and/or require additional components or features to achieve such counter-current operation.

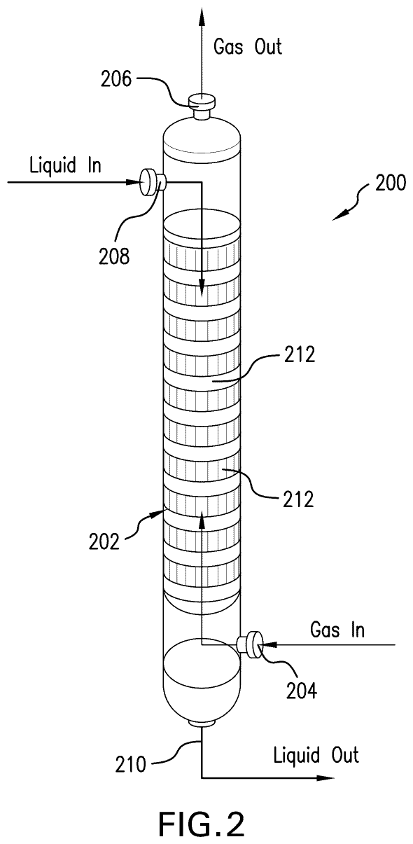

For example, referring to FIG. 2, a schematic illustration of a counter-current absorber 200 is shown. The counter-current absorber 200 includes an absorber vessel 202 that is configured to receive a gas at a gas inlet 204 which is arranged at a bottom end of the vertically oriented absorber vessel 202. The gas is then directed to flow upward toward a gas outlet 206 arranged at a top end of the absorber vessel 202. At the same time, a liquid solvent is introduced to the absorber vessel 202 at the top end at a liquid inlet 208 and the liquid solvent then flows downward and in a direction opposite the flow direction of the gas to a liquid outlet 210. Arranged within the absorber vessel 202 are a series or stack of packing elements 212. The packing elements 212 may be arranged as conventional screens or the like.

However, recent advancements in continuous post-combustion capture technology have demonstrated that the size and cost of equipment can be dramatically reduced through development of new processes (e.g., chemical and/or mechanical). One technology that can increase the mass-transfer between a gas stream (e.g., carbon-rich flue gasses) and an absorbent liquid solvent is called a Regenerative Froth Contactor (RFC). The primary mechanism of an RFC system allows increased mass transfer through the generation of a pulsating flow regime inside a gas-liquid contactor such that the majority of the internal volume of the contactor is occupied by a pulsating froth of micro-scale gas bubbles and liquid droplets. An RFC system may be substantially passive in the sense that the frothing is achieved by suppling a substantially constant pressure and flowrate of the gas and liquid solvent through a vessel having a series of packing elements (e.g., screens or the like).

An RFC may employ specialized Corrugated Screen Packing (CSP) to produce a pulsing gas/liquid flow regime inside an absorber vessel. Corrugated Screen Packing and arrangements thereof are described in European Patent No. 2,675,548, the contents of which are incorporated herein in their entirety. Such pulsing of the gas/liquid mixture may be dependent on the geometric architecture of the packing arrangement (CSP) and the particular flowrates of liquid and gas used. Arrangements of CSP with flowrates of liquid and gas sufficiently high enough to achieve a high mass-transfer rate requires significant pumping power to overcome undesirable pressure drops due to the nature of the CSP. That is, the complex nature of the CSP may require additional pressure and/or flow rate production to ensure that the liquid-gas mixture is sufficiently passed through the CSP. Such configurations may result in large liquid pumping and gas compression equipment that is costly to install, maintain, and operate.

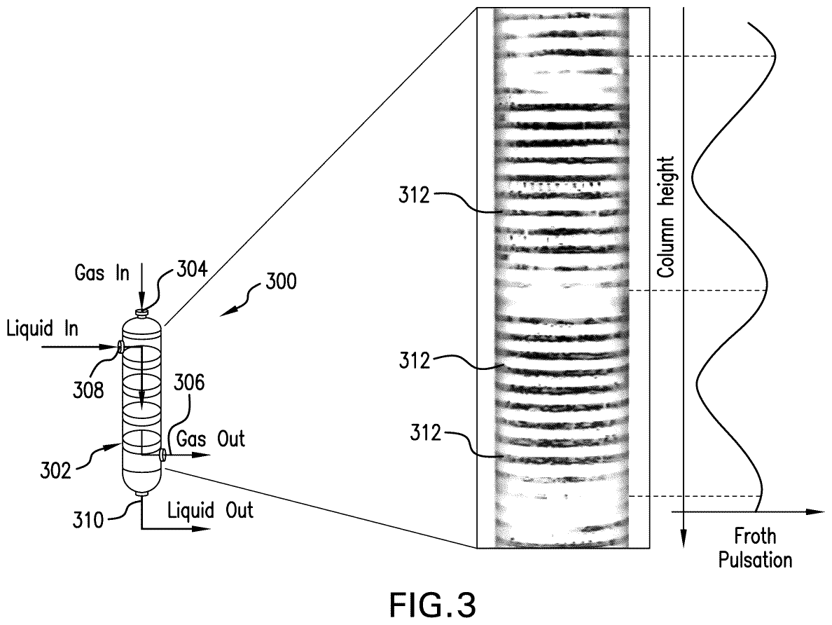

Referring to FIG. 3, a schematic illustration of a co-current absorber 300 is shown. The co-current absorber 300 includes an absorber vessel 302 that is configured to receive a gas at a gas inlet 304 which is arranged at a top end of the vertically oriented absorber vessel 302. The gas is then directed to flow downward toward a gas outlet 306 arranged at a bottom end of the absorber vessel 302. At the same time, a liquid solvent is introduced to the absorber vessel 302 at the top end at a liquid inlet 308 and the liquid solvent then flows downward and in a direction parallel or the same as the flow direction of the gas to a liquid outlet 310. Arranged within the absorber vessel 302 are a series or stack of packing elements 312. The packing elements 312 may be arranged as Corrugated Screen Packing (CSP), as described above. As shown in the enlarged view of FIG. 3, the introduction of the packing elements 312 in the form of CSP may result a froth pulsation that is achieved through a combination of flow rate, flow pressure, characteristics of the absorber vessel 302, and, primarily, characteristics of the packing elements 312.

Although the co-current absorber vessel 302 of the configuration using CSP, shown in FIG. 3, may be smaller than counter-current absorber vessel 202 of FIG. 2, to achieve the desired absorption, various alternative operational parameters may be required to be adjusted with the co-current absorber vessel 302 of the configuration using CSP, shown in FIG. 3. For example, increased pressure and/or flow rate of the gas stream and/or the liquid solvent may be required to ensure that sufficient absorption occurs during the passage of the two fluids through the absorber vessel 302.

The ability to generate the desired pulsating and/or fluctuating flow regime fundamental to an RFC with less restriction on packing design could reduce the size, cost, and power required to drive fluids through the contactor. Accordingly, in some embodiments of the present disclosure, fluctuations are introduced to the pressure of a liquid and/or a gas flow passage and/or within the absorber vessel. Such fluctuations may be introduced, in accordance with some non-limiting embodiments, through passive mechanisms, such as paddlewheels, restricted orifices, and/or active mechanisms, such as fast-acting control valves, electromagnetic solenoids (e.g., voice coils and/or acoustic drivers), or the like.

In accordance with embodiments of the present disclosure, the generation and perpetuation of highly mixed gas-liquid flows may be enhanced. Further, in accordance with some embodiments, a dependence of the flow regime on the geometric configuration of the contactor internal packing elements (e.g., screen assemblies) may be reduced. As a result, in accordance with some embodiments of the present disclosure, the internal packing elements may then be formed of a less restrictive architecture, and thus the pressure drop and the associated costs of equipment required to circulate fluids may be reduced.

In accordance with some embodiments of the present disclosure, a gas and/or liquid inlet stream feeding a co-current RFC absorber are introduced with a prescribed fluctuation in pressure and/or flowrate. This is in contrast to the nearly constant pressure and flowrates used by existing RFC systems. Further, in some embodiments, the frequency and/or magnitude of the fluctuations may be tuned according to internal flow dynamics of the absorber vessel (e.g., tower) and components arranged therein (if any). Considering the pressure waves that generate micro-bubble froth pulsations or fluctuations in a repeating pattern along the length of the absorber vessel, a standing-wave may be maintained by exciting a natural frequency of the compressible fluid mixture (e.g., mixture of gas and liquid solvent) within the absorber vessel. In some such configurations, the energy required to maintain a desired set of high-pressure/low-pressure mixture pulsations or fluctuations is thereby reduced. As a result, the absorber vessel and use thereof may be described as a resonator or resonating system, as described herein.

In accordance with some embodiments of the present disclosure, a regenerative froth contactor (RFC) able to produce high mass-transfer rates using energy-efficient resonator principles instead of energy-intensive pumping devices is provided. Such configurations may offer similar reductions in absorber contactor/vessel size and cost at a lower overall operational cost and may provide increased efficiency. Additional benefits, without limitation, may include increased operating range(s), and/or improved turndown. For example, in contrast to traditional RFC configurations, which rely on a particular arrangement of internal packings and require liquid and gas flowrates within a limited range in order to produce pulsing or fluctuating froth, the use of fluctuating liquid/gas pressures, as described herein, can produce pulsing or fluctuating froth to allow a broader range of liquid and gas flowrates. This additionally allows, for example, efficient capture of gaseous elements from a plant from maximum power (e.g., 100% power) down to less than 50% power (e.g., 50%, 40%, 30%, etc. power), which may be referred to as “turndown.”

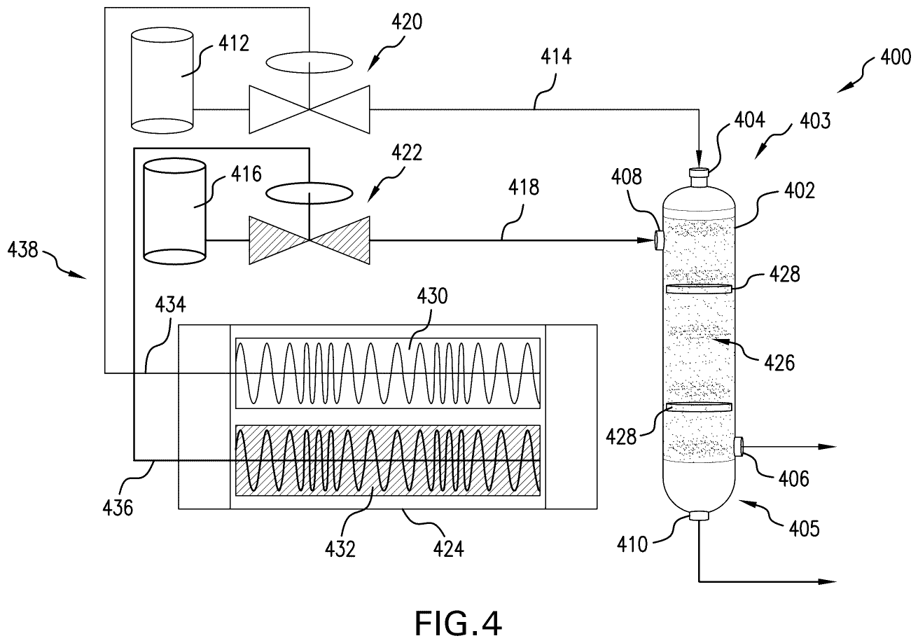

Referring now to FIG. 4, a schematic illustration of a pulsed absorption contactor 400 in accordance with an embodiment of the present disclosure is shown. The pulsed absorption contactor 400 is arranged as a co-current flow system including an absorber vessel 402 having a gas inlet 404, a gas outlet 406, a liquid inlet 408, and a liquid outlet 410. The co-current flow is achieved by the gas inlet 404 and the liquid inlet 408 being arranged at a top end (or inlet end 403) of the absorber vessel 402 and the gas outlet 406 and the liquid outlet 410 being arranged at a bottom end (or outlet end 405) of the absorber vessel 402.

As shown, gas is supplied to the gas inlet 404 from a gas source 412 along a gas supply line 414. Similarly, liquid is supplied to the liquid inlet 408 from a liquid source 416 along a liquid supply line 418. The gas source 414 may be an industrial processing plant, equipment for industrial processing, or any other type of source for a gas that may require removal of one or more target compounds (e.g., CO₂, methane, oxides of nitrogen, oxides of sulfur, etc.). The liquid source 418 may be a source of a solvent or the like that is used in the pulsed absorption contactor 400 and selected to absorb the target compound(s). In some configurations, the sources 414, 418 may be part of a closed-loop or partially closed-loop system, such that the output at the outlets 406, 410 may be recycled or recirculated back to the respective source 414, 418. It will be appreciated that the gas at the gas inlet 404 may be compositionally different than the gas at the gas outlet 406. As such, the gas inlet 404 may be configured to receive an input gas and the gas outlet 406 may be configured to direct an output gas out of the absorber vessel 402. Similarly, due to the absorption of a target compound, chemical, or component, an input liquid at the liquid inlet 408 may be different from a composition of an output liquid at the liquid outlet 410. For example, the input gas may include a high proportion of a target component (e.g., chemical, compound, composition of matter, etc.) and, the output gas may have a relatively low proportion of the target component. In contrast, the input liquid may have a relatively low proportion of the target component, but the output liquid may comprise a relatively high proportion of the target component, due to the absorption of the target component into the liquid solvent.

The pulsed absorption contactor 400 is configured to actively induce or produce a fluctuation in a mixture of the gas and the liquid within the absorber vessel 402. To generate such fluctuations, in this configuration, a gas pulser 420 is arranged along the gas supply line 414 and a liquid pulser 422 is arranged along the liquid supply line 418. The gas pulser 420 is configured to impart a fluctuation into the flow of the gas as it flows through the gas supply line 414 and such fluctuation generates a pulse or fluctuation that continues as the gas flows into and through the absorber vessel 402. Similarly, the liquid pulser 422 is configured to impart a fluctuation into the flow of the liquid as it flows through the liquid supply line 418 and such fluctuation generates a pulse or fluctuation that continues as the liquid flows into and through the absorber vessel 402.

The fluctuations that are generated by the respective pulsers 420, 422 may be sourced from or controlled by at least one pulse generator 424. The pulse generator 424 may be configured to control the pulsers 420, 422 such that a flow of the fluid (e.g., gas or liquid) is imparted with a pulse of different pressure (e.g., compression pulse, pressure wave, etc.), such that a consistent pulse pattern is imparted to the respective fluid. Such fluctuations may be introduced, in accordance with some non-limiting embodiments, through passive mechanisms, such as paddlewheels, restricted orifices, etc. and/or active mechanisms, such as fast-acting control valves, electromagnetic solenoids (e.g., voice coils, acoustic drivers, etc.), etc. and/or combinations thereof (e.g., combination of both active and passive fluctuation generators). When the pulsed fluid enters the absorber vessel 402, the pulsed fluid will interact with the other fluid, which can be another pulsed fluid or a non-pulsed fluid. For example, a specific pulse regime may be imparted to the gas flow through the gas pulser 420. As the gas flows along the gas supply line 414 it will then enter the absorber vessel 402 with the pulse and then propagate through the absorber vessel 402 from inlet end 403 toward the outlet end 405. Similarly, a pulsed liquid will enter and propagate through the absorber vessel 402 with an imparted pulse signal from the liquid pulser 422.

In this non-limiting configuration, due to the imparted pulses or fluctuations in the gas and the liquid, a standing wave 426 may be generated within the absorber vessel 402. Due to the compression and condensing of the particles of the fluids at the peaks of the standing wave 426, sufficient agitation may occur to cause bursting, shattering, fragmenting, or breaking up bubbles of the aqueous froth into a myriad of droplets and micro-droplets of different radii. This may result in a high efficiency of absorption of the gas into the liquid solvent. In some non-limiting configurations, the absorber vessel 402 may include one or more packing elements 428. The packing elements 428 may be similar to the screens and meshes described with respect to the configuration of FIGS. 1-2 and/or similar to the Corrugated Screen Packing (CSP) system described with respect to the configuration of FIG. 3. In other embodiments, packing elements may be omitted entirely. Further, various combinations of multiple similar or different packing elements may be employed in combination with the pulsed fluids described herein.

In operation, the pulsed absorption contactor 400 will supply pulsed fluids into the absorber vessel 402 where a mixture will froth and allow the liquid portion (e.g., solvent) to absorb gas molecules of the gas portion (e.g., CO₂-rich gas). In a non-limiting example, the gas and/or liquid inlet streams (e.g., supply lines 414, 418) feeding a co-current RFC absorber (e.g., absorber vessel 402) are introduced with a prescribed fluctuation in pressure and flowrate (e.g., pulsers 420, 422 in combination with pulse generator 424). Such configuration is in comparison to the nearly constant pressure and flow used by existing contactors (e.g., similar to that described in FIGS. 2-3).

To impart or cause the generation of the pulses or fluctuations within the fluids (gas and/or liquid), the pulse generator 424 may, in some embodiments, be an electronic controller. The pulse generator 424 may define a gas pulse signal 430 and a liquid pulse signal 432, which are transmitted to the respective pulsers 420, 422, along communication lines 434, 436, respectively. The transmission of the pulse signals 430, 432 may be through a wired or wireless connection, if such signals are electronic. However, in other embodiments, the pulse signals may be hydraulic signals or pulses, mechanical signals (e.g., based on a clock or the like), or through some other mechanism(s) as will be appreciated by those of skill in the art. Further, in some embodiments, the gas pulser 420 may include an integral or integrated pulse generator and the liquid pulser 422 may include an integral or integrated pulse generator, and thus the pulse generator 424 illustrated in FIG. 4 may be omitted. The pulse signals 430, 432 may be used to control the pulsers 420, 422 to impart a pressure wave into the flow of the respective fluid. In such cases, the pulsers 420, 422 may be electronically controlled or operated valves, turbines, paddle wheels, fan, adjustable orifice, gate/door controlling a controlled volume of the respective fluid, or the like. Such control may be referred to as active pulse generation.

In accordance with some embodiments of the present disclosure, the pulse generator 424 may be configured to impart the same frequency, amplitude, waveform or other feature into both the gas and liquid streams. In other embodiments, the two imparted pulses may be different in one or more aspects of the imparted waveform. Further, for example, the pulse signal of one of the gas or liquid streams may be a harmonic of the other, such that the two pulse signals are related, but may not be identical or substantially similar. The tuning of each pulse signal 430, 432 may be selected to achieve a desired agitation and intermixing of the mixed fluid within the absorber vessel 402.

In other embodiments, the pulse generation may be referred to as passive pulse generation. In such configurations, the system is designed to naturally generate the desired pressure waves, fluctuations, pulses, etc. within the respective fluid(s). It will be appreciated by those of skill in the art that the terms pulse and fluctuations may be used interchangeably herein, and the specific terminology of “pulse” is not intended to impart a specific type of pulse or fluctuation, but rather is intended to capture an induced change in pressure or flowrate in the subject fluid(s). For example, a turbine, paddle wheel, fan, orifice, and/or a controlled volume of the fluids may be used in a passive manner. For example, such turbines, wheels, fans, rotating baffle(s), and the like may be configured to rotate due to the supply of the respective fluid through the supply lines 414, 418. As the fluid interacts with the passive device within the supply line, a pressure pulse may be generated and then propagated into and through the absorber vessel 402. Similarly, pulses may be generated by selecting an orifice of sufficient size or properties to cause a restriction within the flow of the fluid, and upon reaching a predetermined pressure, the orifice may open to permit a compressed portion of the fluid to pass through and into the absorber vessel 402. A fixed volume may similarly be used. It will be appreciated that the above are merely examples of means and mechanisms for imparting a pressure pulse to a fluid, whether actively or passively.

Although shown in FIG. 4 with both the gas and the liquid having respective pulsers 420, 422, such configuration is not intended to be limiting. For example, in some embodiments, only one of the two fluids may have the pulse generated therein. For example, in one non-limiting example, the liquid solvent may be sprayed (e.g., as a fine mist) into the inlet end 403 of the absorber vessel 402. However, the gas may have a gas pulser 420 that imparts a pressure wave into the gas along the gas supply line 414 and/or as the gas is introduced into the absorber vessel 402 at the gas inlet 404. In such a configuration, the pulse imparted into the gas is the primary driving mechanism for generating the froth and mixture to agitate sufficiently for absorption of the target compound into the liquid solvent. In such a configuration, a standing wave may still be formed, but such standing wave is generated solely by the gas portion of the system. In other embodiments, the reverse may be true, with the pulse imparted to the liquid solvent, and the gas not having a pulse imparted thereto. As such, it will be appreciated that various different configurations are possible without departing from the scope of the present disclosure.

As shown in FIG. 4, the pulsed absorption contactor 400 is arranged as a co-current flow system including an absorber vessel 402 having a gas inlet, a gas outlet 406, a liquid inlet 408, and a liquid outlet 410. A pulse generator system 438 is provided to induce the above-described pressure waves 426 along the supply lines of the liquid and/or gas that are input to the absorber vessel 402. The pulse generator system 438 of this illustrative configuration includes, at least, the pulse generator 424, the pulsers 420, 422, and the packing elements 428. It will be appreciated that the pulse generator system 438 may be configured with various other components and/or arrangements thereof, as will be appreciated in view of the teachings herein.

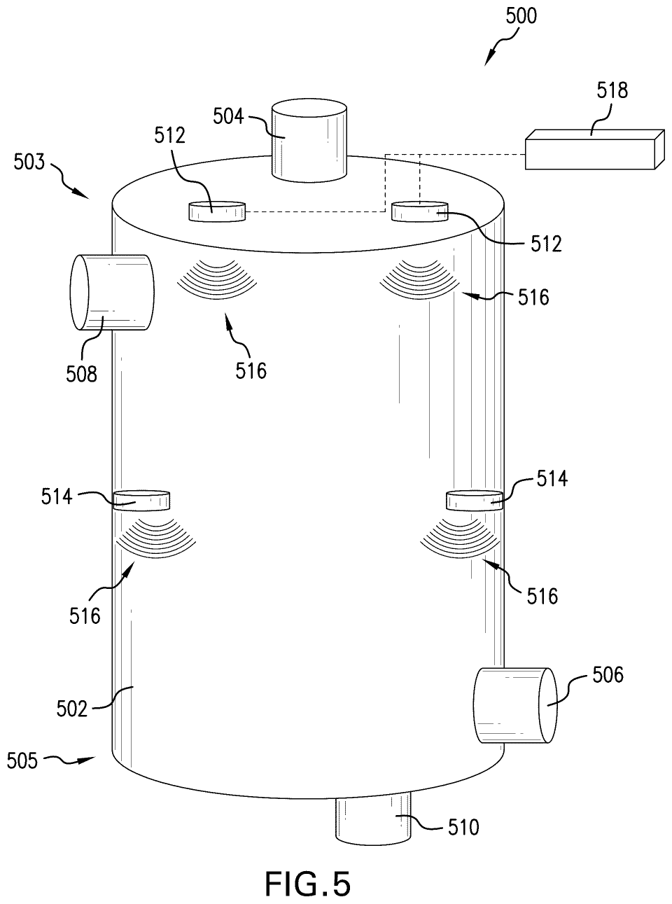

Referring now to FIG. 5, a schematic illustration of a pulsed absorption contactor 500 in accordance with an embodiment of the present disclosure is shown. The pulsed absorption contactor 500 is arranged as a co-current flow system including an absorber vessel 502 having a gas inlet 504, a gas outlet 506, a liquid inlet 508, and a liquid outlet 510. The co-current flow is achieved by the gas inlet 504 and the liquid inlet 508 being arranged at a top end (or inlet end 503) of the absorber vessel 502 and the gas outlet 506 and the liquid outlet 510 being arranged at a bottom end (or outlet end 505) of the absorber vessel 502.

In this configuration, the imparted pressure wave is introduced within the absorber vessel 502 itself, and not along the supply lines of the liquid or gas that are input into the absorber vessel 502. As such, the gas and/or liquid may be deposited or injected into the absorber vessel 502 through spray nozzles, duct openings, gas nozzles, or the like, as will be appreciated by those of skill in the art. With the gas and liquid portions introduced into the absorber vessel 502, the two fluids will mix. To increase the mixing and absorption of the gas into the liquid, a pressure wave may be introduced into the system with one or more pulsers 512, 514. The pulsers 512, 514 are arranged on or in the absorber vessel 502 and are configured to generate pressure waves 516 within the absorber vessel 502.

The pulsers 512, 514 may be acoustic wave generators, vibration generators or the like. As shown, the pulsers 512, 514 are arranged in sets, with a first set of pulsers 512 arranged at the inlet end 503 of the absorber vessel 502 and a second set of pulsers 514 arranged between the inlet end 503 and the outlet end 505 of the absorber vessel 502. In some embodiments, only one set of pulsers 512 may be provided at the inlet end 503 of the absorber vessel 502. The second set of pulsers 514 may be optionally included to ensure that the generated pressure wave (e.g., a standing wave) is maintained for the full length of the absorber vessel 502 from the inlet end 503 to the outlet end 505. The second set of pulsers 514 may be arranged within an interior of the absorber vessel 502, and may optionally be configured with or associated with a packing element or the like. The pulsers 512, 514 may be controlled, for example, by a pulse generator 518, which may be in wired or wireless communication with the pulsers 512, 514. As a result, a standing pressure wave may be generated within the absorber vessel 502 and cause the mixture of gas and liquid bubbles to burst, shatter, fragment, or break up into a myriad of droplets and micro-droplets, and the gas may be absorbed into the liquid. Although shown with two first pulsers 512 and two second pulsers 514, it will be appreciated that the number of pulsers in a given set and/or the number of sets of pulsers may be adjusted to fit the particular application, and such specific number and arrangement as shown in FIG. 5 is not intended to be limiting.

Similar to the above-described embodiments, the absorber vessel 502 may include one or more packing elements 428. The packing elements 428 may be similar to the screens and meshes described with respect to the configuration of FIGS. 1-2 and/or similar to the Corrugated Screen Packing (CSP) system described with respect to the configuration of FIG. 3. In other embodiments, packing elements may be omitted entirely. Further, various combinations of multiple similar or different packing elements may be employed in combination with the pulsed fluids described herein. In some embodiments, due to the induced pressure waves, the number and features of packing elements may be reduced or simplified, and thus additional costs and complexity savings may be achieved. For example, rather than a corrugated screen, in some embodiments, a simple mesh or screen or even a plate with holes may be employed. These more simplistic packing elements may be configured merely as nucleation devices to provide surfaces upon which the fluid may collect and then cause absorption of the target gas, compound, chemical, or component within the liquid portion of the mixture.

Although the configuration of FIG. 5 locates the pulsers 512, 514 on or in the absorber vessel, such configuration of vibration inducing systems (e.g., acoustic, hydraulic, mechanical, etc.) is not intended to be limiting. For example, in some configurations, similar pulsers that generate pressure waves through vibrations may be arranged along supply lines of the gas and/or liquid that are injected or supplied into the absorber vessel. Further, in other embodiments, the pulsers may be integrated into or arranged to impart vibrations into one or more packing elements that are positioned within the absorber vessel (e.g., packing elements 428 shown in FIG. 4). As such, the vibration-type pulsers may be used at various locations on pulsed absorption contactor systems, and the illustrated configurations are merely provided for illustrative and explanatory purposes.

As discussed above, embodiments of the present disclosure are directed to actively generating a pressure wave (e.g., compression wave, fluctuations, vibrations, etc.) within the gas, the liquid solvent, and/or the mixture thereof. Such a pressure wave, when actively induced, may cause regions of compression within an absorber vessel. These compressed regions, in combination with the flow of the fluid mixture through the absorber vessel (e.g., from inlet to outlet in a co-current manner) will cause the two fluids to intermix and interact such that the gas or a constituent thereof (e.g., target compound(s)) will be captured by the liquid solvent. This induced pressure wave system may be augmented by the inclusion of one or more packing elements, which may be CSP or the like, as described above. Whether such packing elements are included or not, the induced pressure wave could be a standing wave or a traveling wave. To achieve the induced standing wave, various factors have to be considered, such as the fluids employed (both gas and liquid), the nature of the injection of the fluids (e.g., mist, atomized, etc.), the flow rate(s) of the fluids, the pressure of the fluids, and the geometry and other features of absorber vessel itself.

Because such tuning is possible, the pulsed absorption contactors of the present disclosure may be configured as harmonic resonators. That is, in some embodiments of the present disclosure, the frequency and magnitude of the pressure waves (e.g., fluctuations, compression waves, vibrations, etc.) may be tuned according to the internal flow dynamics of the contactor system. Considering the pressure waves that generate micro-bubble froth pulsations in a repeating pattern along the length of the tower (i.e., absorber vessel), a standing-wave is maintained by exciting the natural frequency of the compressible fluid mixture (combination of gas and liquid) within the absorber vessel. By tuning the induced pressure waves to match harmonic frequencies of the physical system, the energy required to maintain the desired set of high-pressure/low-pressure mixture pulsations is thereby reduced. It will be appreciated that absorption contactor systems that are so tuned may be referred to as resonator absorption contactors. Such resonator absorption contactors may provide additional increased efficiencies and/or reduced costs associated with operation thereof, on top of the systems that may not have such tuned pressure waves.

Advantageously, embodiments of the present disclosure provide for improved capture systems for capturing target compounds from a gas stream. In accordance with some embodiments, an actively induced pressure wave is introduced into at least one of a gas stream, a liquid stream, or a mixture thereof. The induced pressure wave will result in regions of high compression between a liquid solvent and a gas within an absorber vessel. The induced pressure wave thereby increases the mixing and interaction of gas bubbles and liquid droplets, increasing the surface area of contact between the two fluids, and thereby increasing the absorption rate or capacity of a liquid solvent. Accordingly, a high extraction and capture of a target compound may be achieved through implementation of embodiments of the present disclosure.

Furthermore, advantageously, embodiments of the present disclosure may enable reduced size and/or cost of a contactor system, as compared to systems without induced pressure waves, as described herein. For example, and without limitation, the systems described herein may achieve a reduced pressure drop as compared to systems without such induced pressure waves. With a reduced pressure drop, pumps, blowers, piping, ducting and other components of the systems may be reduced in size and/or power, or may be eliminated entirely. Accordingly, a lower cost of equipment and lower operating costs may be achieved. Additionally, through a combination with a regenerative froth contactor (RFC), further improvements may be achieved. For example, a pulsed absorption contactor system with RFC may produce mass transfer enhancement (e.g., greater than 6.5×) beyond traditional counter-current absorber systems. Further, advantageously, even with such increased mass transfer (transfer of target compound into liquid solvent), such systems as disclosed herein may not incur a penalty of high-pressure-drop screen packing elements.

Advantageously, embodiments of the present disclosure may provide benefits relative to turndown operations of facilities that employ the pulsed absorption contactors of the present disclosure. For example, in conventional systems, extraction and capture of target compounds, chemicals, or components may be achieved at operation envelops of 100% down to about 75% (e.g., reduced power, pressure etc.). However, operating at below 75% envelop may result in too low of a pressure within the system, and thus the system may not properly function. In contrast, by implementing embodiments of the present disclosure, the operating envelop may be increased to 100% down to about 40%. Accordingly, the systems described herein provide for a significantly larger operational range than systems that do not include the features described herein.

Embodiments of the present disclosure may be used in various applications and/or industries. For example, and without limitation, the pulsed absorption contactors of the present disclosure may be used post-combustion CO₂ capture for industrial processing plants, refineries, power plants, chilled ammonia process (CAP), mixed salt process (MSP), and liquid solvent capture processes. Depending on the specific application, the liquid solvent may be selected to achieve absorption of a specific target compound, chemical, or component. For example, and without limitation, various liquid solvents that may be used with the pulsed absorption contactors of the present disclosure may include monoethanolamine (MEA) solvents, ammonia, enhanced solvents, glycol, and the like, which may be selected to absorb or capture a specific desired target compound, chemical, or component. The target compounds, chemicals, or components may include, for example and without limitation, carbon dioxide, potassium carbonate, ammonia, or others. Furthermore, the pulsed absorption contactors of the present disclosure may be used as a dryer for dehydration of a fluid. It will be appreciated that the above are merely examples, and the pulsed absorption contactors of the present disclosure may be used in various other industries, applications, and/or with other gas streams and/or solvents.

Set forth below are some embodiments of the foregoing disclosure:

Embodiment 1: A pulsed absorption contactor system comprising: a vessel having an inlet end and an outlet end, the vessel comprising: at least one gas inlet arranged at the inlet end of the vessel and configured to direct an input gas stream into the vessel; at least one gas outlet arranged at the outlet end of the vessel and configured to receive an output gas stream and direct the output gas stream out of the vessel; at least one liquid inlet arranged at the inlet end of the vessel and configured to direct an input liquid stream into the vessel; and at least one liquid outlet arranged at the outlet end of the vessel and configured to receive an output liquid stream and direct the output liquid stream out of the vessel; and a pulse generator system configured to induce a fluctuation in at least one of the input gas stream, the input liquid stream, or a combination of the input gas stream and the input liquid stream.

Embodiment 2: The pulsed absorption contactor system of any preceding embodiment, wherein the pulse generator system comprises a gas pulser arranged along the input gas stream and configured to impart a pressure pulse into the input gas stream.

Embodiment 3: The pulsed absorption contactor system of any preceding embodiment, wherein the pulse generator system comprises a liquid pulser arranged along the liquid input stream and configured to impart a pressure pulse into the input liquid stream.

Embodiment 4: The pulsed absorption contactor system of any preceding embodiment, wherein the pulse generator system comprises: a gas pulser arranged along the input gas stream and configured to impart a pressure pulse into the input gas stream; and a liquid pulser arranged along the input liquid stream and configured to impart a pressure pulse into the input liquid stream.

Embodiment 5: The pulsed absorption contactor system of any preceding embodiment, wherein the pressure pulse imparted to the input gas stream is a harmonic of the pressure pulse imparted to the input liquid stream.

Embodiment 6: The pulsed absorption contactor system of any preceding embodiment, wherein the pulse generator system comprises at least one pulse generator configured to control at least one pulser to impart a pulse into at least one of the gas stream and the liquid steam.

Embodiment 7: The pulsed absorption contactor system of any preceding embodiment, further comprising at least one packing element arranged within the vessel.

Embodiment 8: The pulsed absorption contactor system of any preceding embodiment, wherein the at least one packing element comprises corrugated screen packing.

Embodiment 9: The pulsed absorption contactor system of any preceding embodiment, wherein the pulse generator system comprises a vibration generator configured to impart vibrations into at least one of the input gas stream, the input liquid stream, or a mixture of gas and liquid from the input gas stream and the input liquid stream.

Embodiment 10: The pulsed absorption contactor system of any preceding embodiment, wherein the vibration generator is an acoustic wave generator.

Embodiment 11: The pulsed absorption contactor system of any preceding embodiment, wherein the vibration generator comprises at least one pulser arranged on an exterior of the vessel.

Embodiment 12: The pulsed absorption contactor system of any preceding embodiment, wherein the vibration generator comprises at least one pulser arranged within an interior of the vessel.

Embodiment 13: The pulsed absorption contactor system of any preceding embodiment, wherein the input gas stream comprises a target compound and the input liquid stream comprises a solvent selected to capture the target compound.

Embodiment 14: A method for capturing a target component from a gas within a liquid using a pulsed absorption contactor system comprising a vessel having an inlet end and an outlet end and a pulse generator system, the method comprising: supplying an input gas into the vessel through a gas inlet at the inlet end of the vessel; supplying an input liquid into the vessel through a liquid inlet at the inlet end of the vessel; and inducing a pressure wave within the vessel using the pulse generator system configured to induce a pulse in at least one of the input gas, the input liquid, and a mixture of the input gas and the input liquid, wherein an induced pulse from the pulse generator system creates a compression wave of a mixture of the input gas and the input liquid within the vessel.

Embodiment 15: The method of any preceding embodiment, wherein the pulse generator system comprises a gas pulser arranged to impart a pressure pulse into the input gas.

Embodiment 16: The method of any preceding embodiment, wherein the pulse generator system comprises a liquid pulser arranged to impart a pressure pulse into the input liquid.

Embodiment 17: The method of any preceding embodiment, wherein the pulse generator system comprises at least one pulse generator configured to control at least one pulser to impart a pulse into at least one of the input gas, the input liquid, and the mixture of the input gas and the input liquid.

Embodiment 18: The method of any preceding embodiment, further comprising at least one packing element arranged within the vessel.

Embodiment 19: The method of any preceding embodiment, wherein inducing of the pressure wave comprises generating vibrations and inducing the pressure wave into the at least one of the input gas, the input liquid, and the mixture of the input gas and the input liquid.

Embodiment 20: The method of any preceding embodiment, wherein the input gas comprises a target compound and the input liquid comprises a solvent selected to capture the target compound.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of ±8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A pulsed absorption contactor system comprising:
a vessel having an inlet end and an outlet end, the vessel comprising:
at least one gas inlet arranged at the inlet end of the vessel and configured to direct an input gas stream into the vessel;
at least one gas outlet arranged at the outlet end of the vessel and configured to receive an output gas stream and direct the output gas stream out of the vessel;
at least one liquid inlet arranged at the inlet end of the vessel and configured to direct an input liquid stream into the vessel; and
at least one liquid outlet arranged at the outlet end of the vessel and configured to receive an output liquid stream and direct the output liquid stream out of the vessel; and
a pulse generator system configured to induce a fluctuation in at least one of the input gas stream, the input liquid stream, or a combination of the input gas stream and the input liquid stream.

2. The pulsed absorption contactor system of claim 1, wherein the pulse generator system comprises a gas pulser arranged along the input gas stream and configured to impart a pressure pulse into the input gas stream.

3. The pulsed absorption contactor system of claim 1, wherein the pulse generator system comprises a liquid pulser arranged along the liquid input stream and configured to impart a pressure pulse into the input liquid stream.

4. The pulsed absorption contactor system of claim 1, wherein the pulse generator system comprises:
a gas pulser arranged along the input gas stream and configured to impart a pressure pulse into the input gas stream; and
a liquid pulser arranged along the input liquid stream and configured to impart a pressure pulse into the input liquid stream.

5. The pulsed absorption contactor system of claim 4, wherein the pressure pulse imparted to the input gas stream is a harmonic of the pressure pulse imparted to the input liquid stream.

6. The pulsed absorption contactor system of claim 1, wherein the pulse generator system comprises at least one pulse generator configured to control at least one pulser to impart a pulse into at least one of the gas stream and the liquid steam.

7. The pulsed absorption contactor system of claim 1, further comprising at least one packing element arranged within the vessel.

8. The pulsed absorption contactor system of claim 7, wherein the at least one packing element comprises corrugated screen packing.

9. The pulsed absorption contactor system of claim 1, wherein the pulse generator system comprises a vibration generator configured to impart vibrations into at least one of the input gas stream, the input liquid stream, or a mixture of gas and liquid from the input gas stream and the input liquid stream.

10. The pulsed absorption contactor system of claim 9, wherein the vibration generator is an acoustic wave generator.

11. The pulsed absorption contactor system of claim 9, wherein the vibration generator comprises at least one pulser arranged on an exterior of the vessel.

12. The pulsed absorption contactor system of claim 9, wherein the vibration generator comprises at least one pulser arranged within an interior of the vessel.

13. The pulsed absorption contactor system of claim 1, wherein the input gas stream comprises a target compound and the input liquid stream comprises a solvent selected to capture the target compound.

14. A method for capturing a target component from a gas within a liquid using a pulsed absorption contactor system comprising a vessel having an inlet end and an outlet end and a pulse generator system, the method comprising:
supplying an input gas into the vessel through a gas inlet at the inlet end of the vessel;
supplying an input liquid into the vessel through a liquid inlet at the inlet end of the vessel; and
inducing a fluctuation within the vessel using the pulse generator system configured to induce the fluctuation in at least one of the input gas, the input liquid, and a mixture of the input gas and the input liquid, wherein an induced fluctuation from the pulse generator system creates a compression wave of a mixture of the input gas and the input liquid within the vessel.

15. The method of claim 14, wherein the pulse generator system comprises a gas pulser arranged to impart a pressure pulse into the input gas.

16. The method of claim 14, wherein the pulse generator system comprises a liquid pulser arranged to impart a pressure pulse into the input liquid.

17. The method of claim 14, wherein the pulse generator system comprises at least one pulse generator configured to control at least one pulser to impart a pulse into at least one of the input gas, the input liquid, and the mixture of the input gas and the input liquid.

18. The method of claim 14, further comprising at least one packing element arranged within the vessel.

19. The method of claim 14, wherein inducing of the pressure wave comprises generating vibrations and inducing the pressure wave into the at least one of the input gas, the input liquid, and the mixture of the input gas and the input liquid.

20. The method of claim 14, wherein the input gas comprises a target compound and the input liquid comprises a solvent selected to capture the target compound.
